(19) United States
(12) Patent Application Publication
(10) Pub. No.: US 2020/0062276 A1
(43) Pub. Date: Feb. 27, 2020

(54) SYSTEM AND METHOD OF CONTROLLING AUXILIARY VEHICLE FUNCTIONS

(71) Applicant: Faraday&Future Inc., Gardena, CA (US)

(72) Inventors: Shuo YUAN, Redondo Beach, CA (US); Eugene Joseph Lee, Los Angeles, CA (US); Shuai Yang, Redondo Beach, CA (US)

(21) Appl. No.: 16/109,505

(22) Filed: Aug. 22, 2018

(51) Int. Cl. B60W 50/14; G06F 3/0354; G02B 27/01; G06F 3/16; G06F 3/0482; B60W 30/14; B60K 35/00

(52) U.S. Cl. CPC B60W 50/14; G06F 3/03547; G02B 27/0101; G06F 3/165; G06F 3/0485; B60W 30/14; B60K 35/00; G02B 2027/0141; G06F 3/0482

(57) ABSTRACT

A system and method of controlling auxiliary vehicle functions via one or more touchpads on the vehicle steering wheel is disclosed. In response to receiving a user input at one of the touchpads, the vehicle performs a corresponding action depending on the region of the touchpad in which the input was received and the context in which the vehicle is currently operating. During operation, the vehicle displays, on a display screen of the vehicle (e.g., the HUD), a contextual control image indicating which actions will be performed in response to various inputs entered at one or more of the touch pads on the steering wheel. In this way, the steering wheel can accept an input for a variety of auxiliary functions.

### FIELD

The present invention relates generally to a system and method of controlling auxiliary vehicle functions and, more particularly, to a system and method of displaying contextual control images indicating respective actions to be performed in response to a user input received in a respective context of one or more auxiliary vehicle functions.

### BACKGROUND

Current vehicle designs enable vehicles to perform a variety of auxiliary vehicle functions, such as functions that do not directly control actuation of the vehicle for movement. Such auxiliary vehicle functions include audio playback, accepting or declining a phone call, receiving and transmitting audio during a phone call, presenting and dismissing indications of alerts and/or warnings, repositioning one or more components (e.g., seats, mirrors, camera-emulated mirrors, steering wheel, etc.) of the vehicle, and/or activating a driver assistance function (e.g., adaptive cruise control and other autonomous or semi-autonomous driving modes). In some embodiments, one or more of these auxiliary functions are controlled by the user via buttons, switches, soft buttons displayed on a display of the vehicle, and/or voice controls.

Some auxiliary functions are controlled using buttons or switches mounted to a steering wheel of the vehicle. Although buttons and switches mounted to the steering wheel can be convenient to the driver while operating the vehicle, there is a limited amount of space for buttons and switches on one steering wheel, thereby limiting the number of functions that can be controlled by buttons and switches on the steering wheel.

### SUMMARY

The present invention relates generally to a system and method of controlling auxiliary vehicle functions and, more particularly, to a system and method of displaying contextual control images indicating respective actions to be performed in response to a user input received in a respective context of one or more auxiliary vehicle functions. In some embodiments, a vehicle includes one or more touchpads on the vehicle steering wheel.

In accordance with one embodiment, in response to receiving a user input at one of the touchpads, the vehicle performs a corresponding action depending on the region of the touchpad in which the input was received and the context in which the vehicle is currently operating. For example, in one configuration (which may be designated as a default configuration), one of the touch pads optionally controls audio content playing on a speaker of the vehicle and one of the touch pads optionally activates a driver assistance mode. When a phone call (or other forms of communication) is received at a mobile phone (or other types of communication device) in communication with the vehicle, the user is able to enter an input at one of the touch pads for accepting or rejecting the phone call. During a communication session, such as a phone call or other types of real-time session including video sessions, the user is able to enter an input at one of the touch pads for volume up, volume down, mute, and end call. In response to the presentation of a vehicle warning, the user is able to enter an input at one of the touch pads for dismissing the vehicle warning. While navigating a vehicle settings menu, the user can use the touch pad to scroll the menu, return to a higher level of menu hierarchy, and make a selection. When adjusting a vehicle setting (e.g., the position of a component of the vehicle, such as the steering wheel), the user is able to use the touch pad to control the position of the component and confirm the new position. While operating in a driver assistance mode, the user is able to enter an input to control the parameters of the mode, such as increasing or decreasing following distance and increasing or decreasing maximum speed while operating the vehicle with adaptive cruise control.

In accordance with another embodiment, when the vehicle is in a context in which a non-default input can be entered at the touch pads, the vehicle displays, on a display screen of the vehicle (e.g., the HUD), a contextual control image indicating which actions will be performed in response to various inputs entered at one or more of the touch pads on the steering wheel. In this way, the steering wheel can accept an input for a variety of auxiliary functions with a reduced number of buttons.

### BRIEF DESCRIPTION OF THE DRAWINGS

FIG. 1 illustrates a system block diagram of a vehicle control system according to examples of the disclosure.

FIG. 2 illustrates an interior of a vehicle according to examples of the disclosure.

FIGS. 3A-3C illustrate operation of a vehicle when receiving a phone call and during a phone call according to examples of the disclosure.

FIG. 4 illustrates a process for performing phone call operations at a vehicle according to examples of the disclosure.

FIGS. 5A-5C illustrate media player control operations of a vehicle according to examples of the disclosure.

FIG. 6 illustrates a process for performing media control operations at a vehicle according to examples of the disclosure.

FIGS. 7A-7B illustrate operation of a vehicle while adjusting a vehicle setting according to examples of the disclosure.

FIG. 8 illustrates a process for performing vehicle settings operations at a vehicle according to examples of the disclosure.

FIGS. 9A-9C illustrate operation of a vehicle when a warning is generated by the vehicle according to examples of the disclosure.

FIG. 10 illustrates a process for presenting and dismissing a vehicle warning at a vehicle according to examples of the disclosure.

FIGS. 11A-D illustrate operation of a vehicle when performing driver assistance functions according to examples of the disclosure.

FIG. 12 illustrates a process for performing driver assistance operations at a vehicle according to examples of the disclosure.

### DETAILED DESCRIPTION

In the following description, references are made to the accompanying drawings that form a part hereof, and in which it is shown by way of illustration specific examples that can be practiced. It is to be understood that other examples can be used and structural changes can be made without departing from the scope of the disclosed examples. Further, in the context of this disclosure, “autonomous driving” (or the like) can refer to autonomous driving, partially autonomous driving, and/or driver assistance systems.

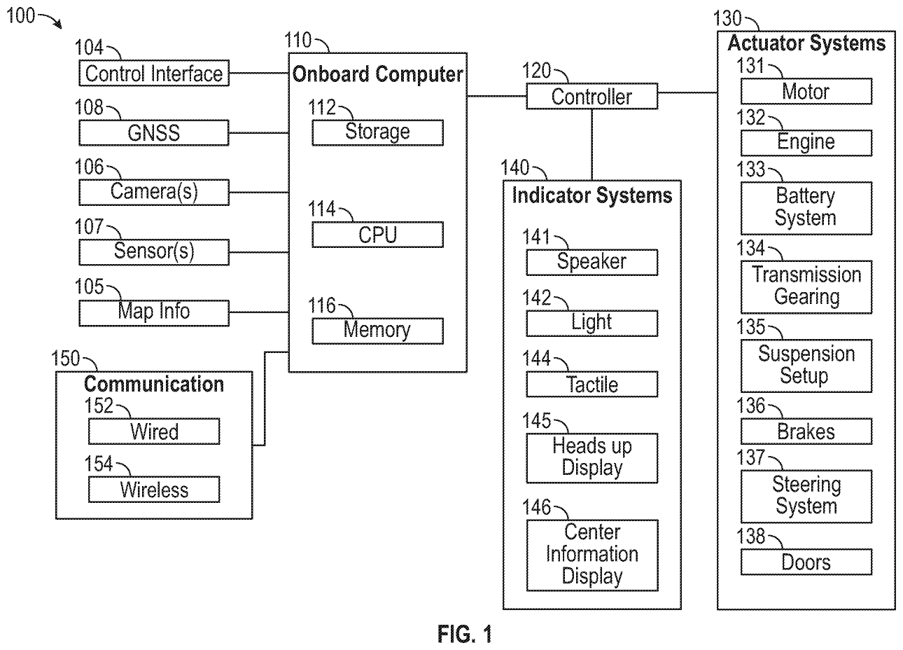

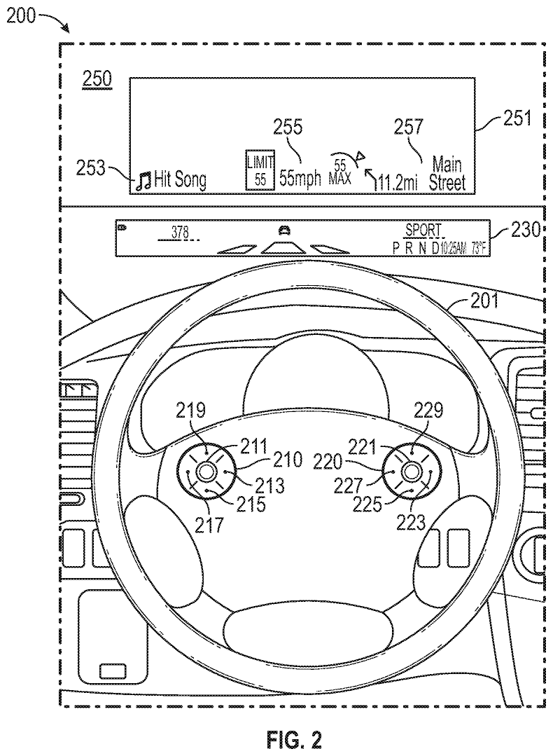

FIG. 1 illustrates a system block diagram of vehicle control system 100 according to examples of the disclosure. Vehicle control system 100 can perform any of the methods described with reference to FIGS. 2-12 below. System 100 can be incorporated into a vehicle, such as a consumer automobile. Other example vehicles that may incorporate the system 100 include, without limitation, airplanes, boats, or industrial automobiles. In some embodiments, vehicle control system 100 includes one or more cameras 106 capable of capturing image data (e.g., video data) for determining various features of the vehicle's surroundings. Vehicle control system 100 can also include one or more other sensors 107 (e.g., radar, ultrasonic, LIDAR, IMU, suspension level sensor, etc.) capable of detecting various features of the vehicle's surroundings, and a Global Navigation Satellite System (GNSS) receiver 108 capable of determining the location of the vehicle. It should be appreciated that GNSS receiver 108 can be a Global Positioning System (GPS) receiver, BeiDou receiver, Galileo receiver, and/or a GLONASS receiver. Vehicle control system 100 can receive (e.g., via an internet connection) feature map information via a map information interface 105 (e.g., a cellular internet interface, a Wi-Fi internet interface, etc.). In some examples, vehicle control system 100 can further include a communication system 150 configured for sending information to and receiving information from augmented reality (AR) driving glasses. The communication system 150 can include one or more of a wired communication interface 152 and a wireless communication interface 153. In some embodiments, the wired communication interface 152 includes a port for connecting the AR driving glasses to the vehicle by way of a cable or other wired connection. The wireless communication interface 154 includes a transceiver for communicating with the AR driving glasses via a wireless protocol.

Vehicle control system 100 further includes an on-board computer 110 that is coupled to the cameras 106, sensors 107, GNSS receiver 108, map information interface 105, and communication system 150 and that is capable of receiving outputs from the sensors 107, the GNSS receiver 108, map information interface 105, and communication system 150. The on-board computer 110 is capable of transmitting information to the AR driving glasses to cause the AR driving glasses to display one or more images, generate one or more tactile alerts, change lens tint, and/or change lens focus. Additional functions of the AR glasses controlled by the on-board computer 110 are possible and are contemplated within the possession of this invention. On-board computer 110 includes one or more of storage 112, memory 116, and a processor 114. Processor 114 can perform the methods described below with reference to FIGS. 2-12. Additionally, storage 112 and/or memory 116 can store data and instructions for performing the methods described with reference to FIGS. 2-12. Storage 112 and/or memory 116 can be any non-transitory computer readable storage medium, such as a solid-state drive or a hard disk drive, among other options that are known in the art.

In some embodiments, the vehicle control system 100 is connected to (e.g., via controller 120) one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137 and door system 138. The vehicle control system 100 controls, via controller 120, one or more of these actuator systems 130 during vehicle operation; for example, to control the vehicle during fully or partially autonomous driving operations, using the motor 131 or engine 132, battery system 133, transmission gearing 134, suspension setup 135, brakes 136 and/or steering system 137, etc. Actuator systems 130 can also include sensors that send dead reckoning information (e.g., steering information, speed information, etc.) to on-board computer 110 (e.g., via controller 120) to determine the vehicle's location and orientation. The one or more indicator systems 140 can include, but are not limited to, one or more speakers 141 in the vehicle (e.g., as part of an entertainment system in the vehicle), one or more lights 142 in or on the vehicle, one or more displays 143 in the vehicle (e.g., as part of a control or entertainment system in the vehicle) and one or more tactile actuators 144 in the vehicle (e.g., as part of a steering wheel or seat in the vehicle). The vehicle control system 100 controls, via controller 120, one or more of these indicator systems 140 to provide visual and/or audio indications, such as an indication that a driver will need to take control of the vehicle, for example.

FIG. 2 illustrates an interior of a vehicle 200 according to examples of the disclosure. In some embodiments, the vehicle 200 includes steering wheel 201, instrument cluster 230, and windshield 250. Steering wheel 201 optionally includes a first touch pad 210 and a second touch pad 220. The windshield 250 optionally includes a heads-up display (HUD) 251 that displays an image projected onto the windshield by a projector (not shown) mounted behind the steering wheel 201 or in another suitable location inside of the vehicle 200. HUD 251 optionally displays information such as media control information 253, cruise control information 255, and navigation information 257.

In some embodiments, the first touch pad 210 and the second touch pad 220 comprise touch sensors (e.g., capacitive touch sensors, resistive touch sensors, piezoelectric touch sensors), buttons, or other suitable mechanisms for detecting user input at each of a plurality of input regions 211-219 and 221-229. Rather than assigning a specific function to each input region 211-219 and 221-229 of the touch pads 210 and 220, in some embodiments, the operation associated with each input region 211-219 and 221-229 changes depending on the operation context of the vehicle.

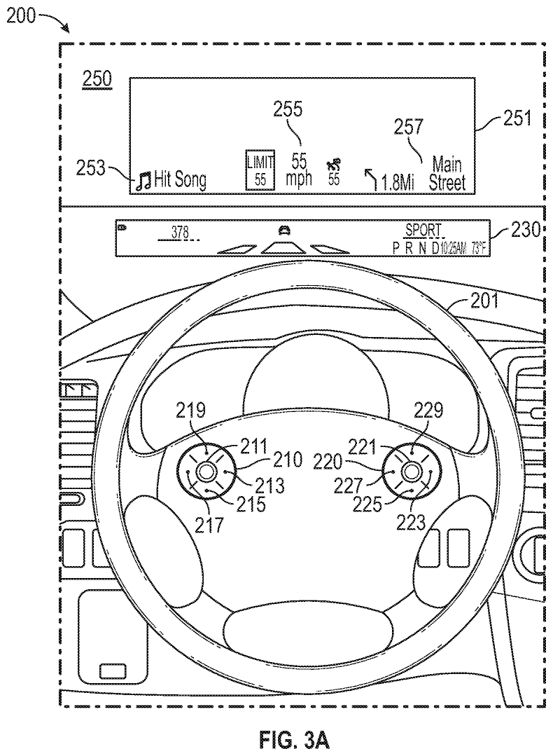

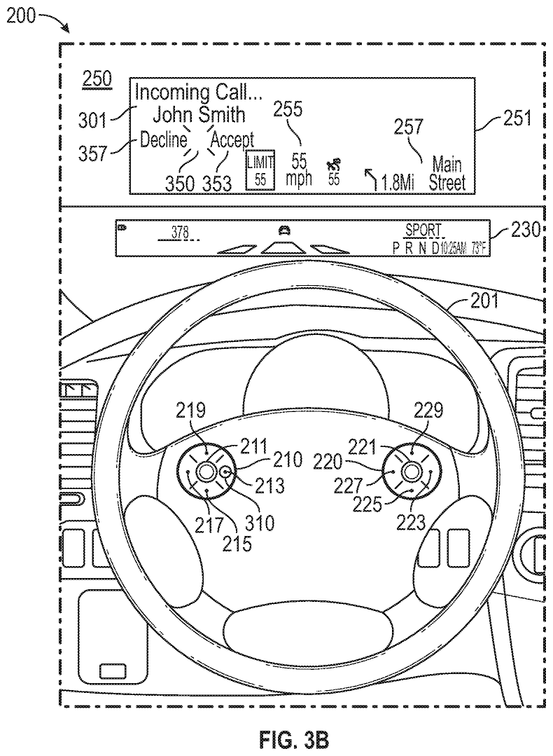

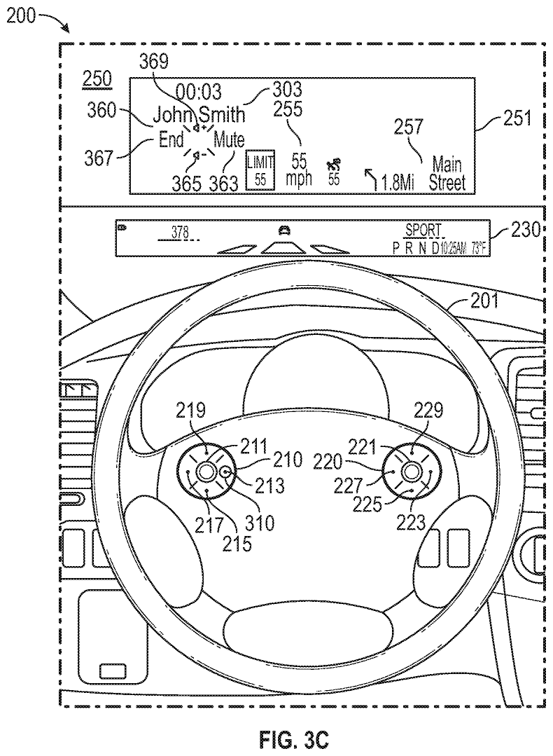

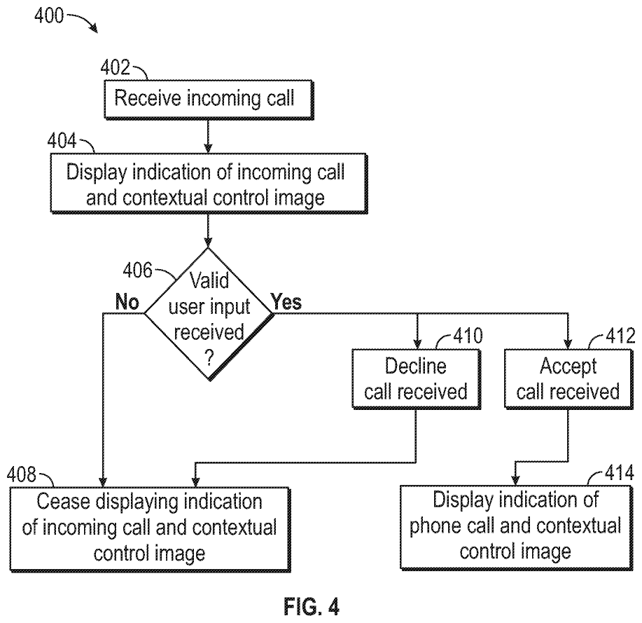

For example, when an incoming call is received at a mobile phone in communication with the vehicle (e.g., via communication 150), inputs received at touch pad 210 or 220 perform operations related to the incoming phone call (e.g., accept the call or decline the call), as will be described in more detail below with reference to FIGS. 3A-3C and 4. During a phone call conducted with the mobile phone in communication with the vehicle, one or more speakers of the vehicle (e.g., speakers 141), and a microphone of the vehicle, inputs received at touch pad 210 or 220 perform operations related to the current phone call (e.g., volume up, volume down, mute, end call), for example, as will be described in more detail below with reference to FIGS. 3A-3C and 4. In some embodiments, when the control configuration of one or both of the touch pads 210 and 220 changes (e.g., when a call is received or a call is initiated), a contextual control image (not shown) is displayed on the HUD 251 to indicate to the user which operations are associated with each input region 211-219 and 221-229 of the touch pads 210 and 220.

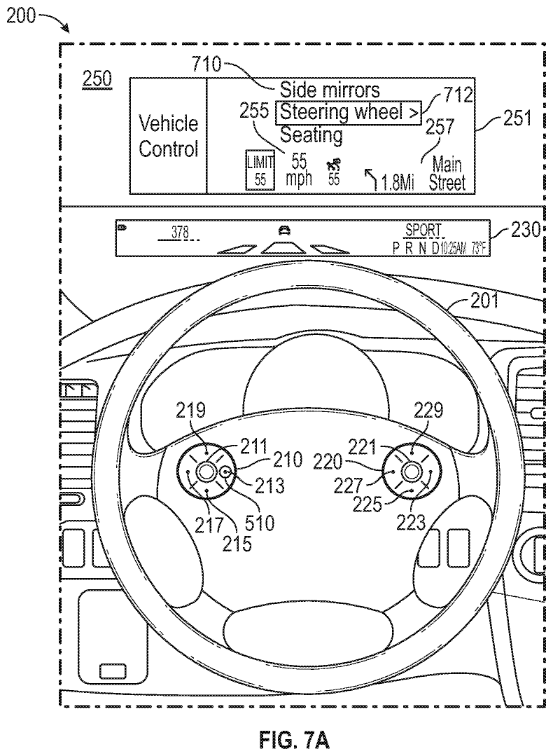

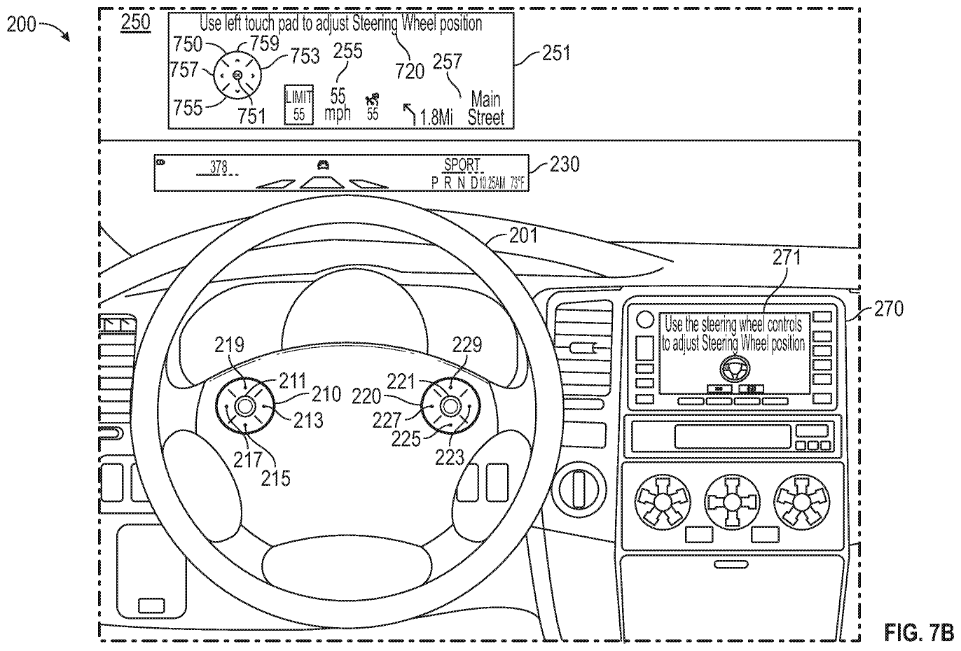

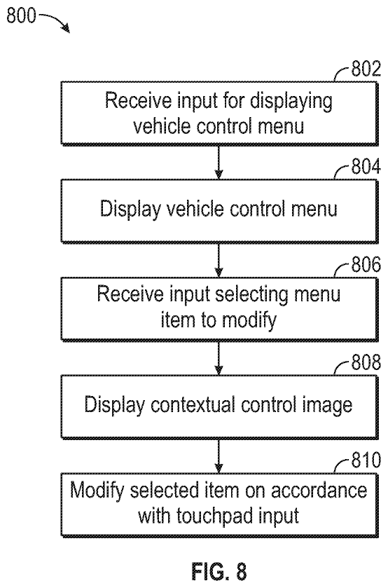

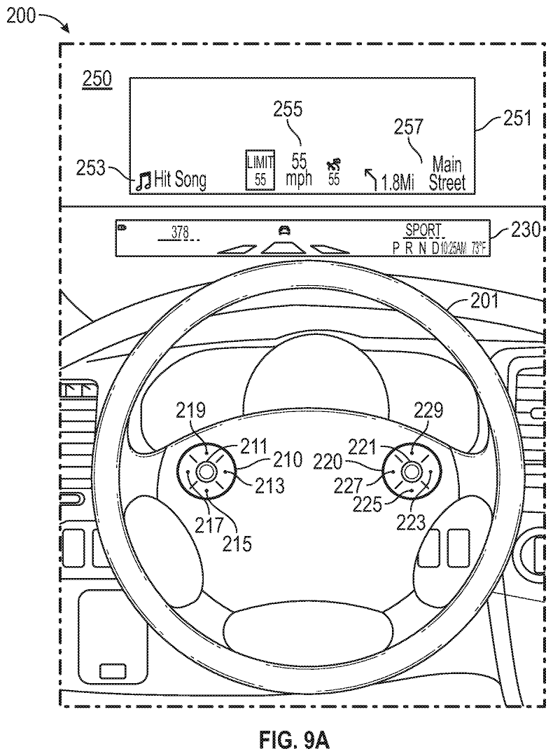

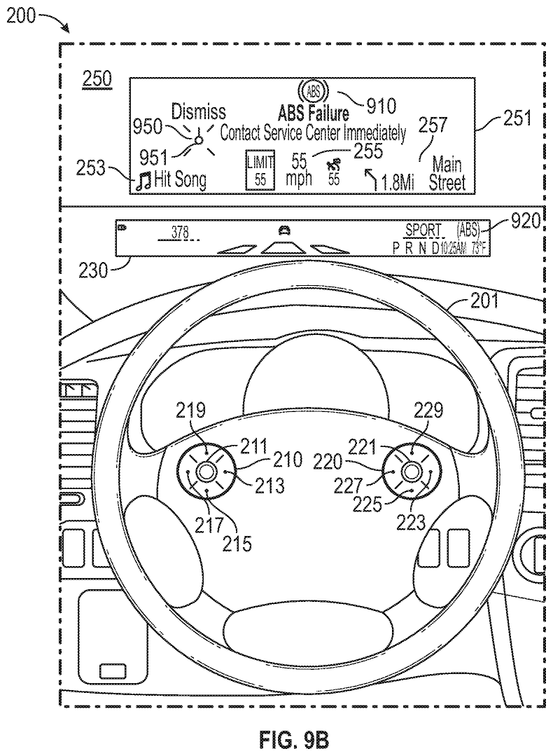

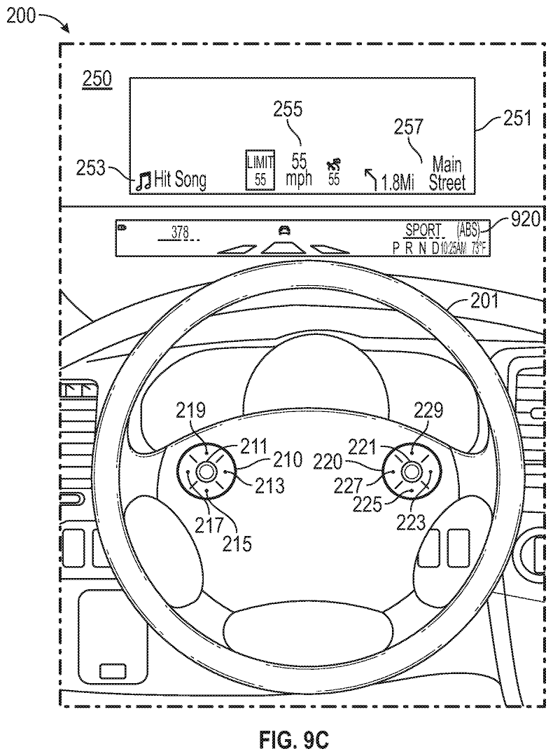

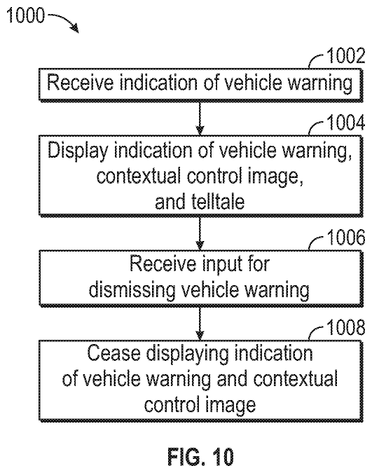

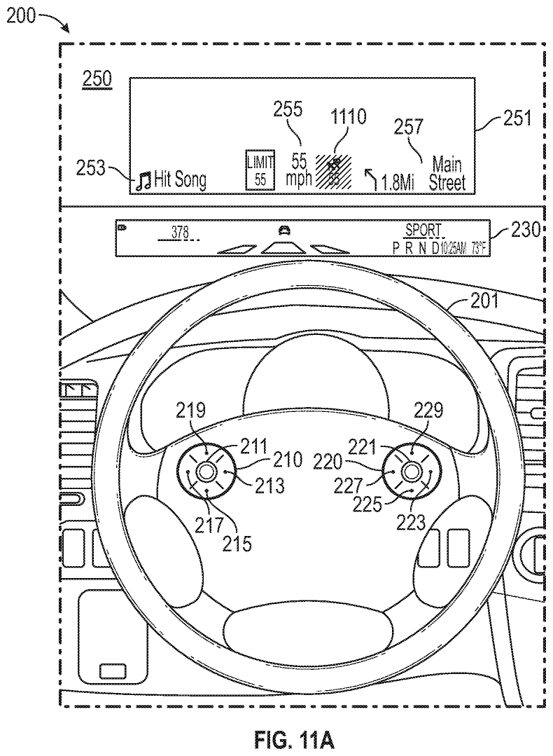

In some embodiments, touch pad 210 or 220 are able to operate to control content displayed on the HUD 251. For example, in response to receiving a vehicle alert (e.g., an indication of a system malfunction or required maintenance), the HUD 251 optionally displays a visual indication of the alert and a contextual control image indicating that one of the touch pads 210 or 220 is configured to accept an input to dismiss the alert, as will be described below with reference to FIGS. 9A-9C and 10. As another example, touch pad 210 or 220 can be configured to navigate a menu presented on the HUD 251, such as a vehicle settings menu including a plurality of menu items for repositioning components of the vehicle (e.g., the steering wheel 201, one or more seats, one or more mirrors, etc.). In some embodiments, one or more vehicle components can be repositioned by the user via user input entered at one of the touch pads 210 or 220, as will be described in more detail below with reference to FIGS. 7A-7B and 8.

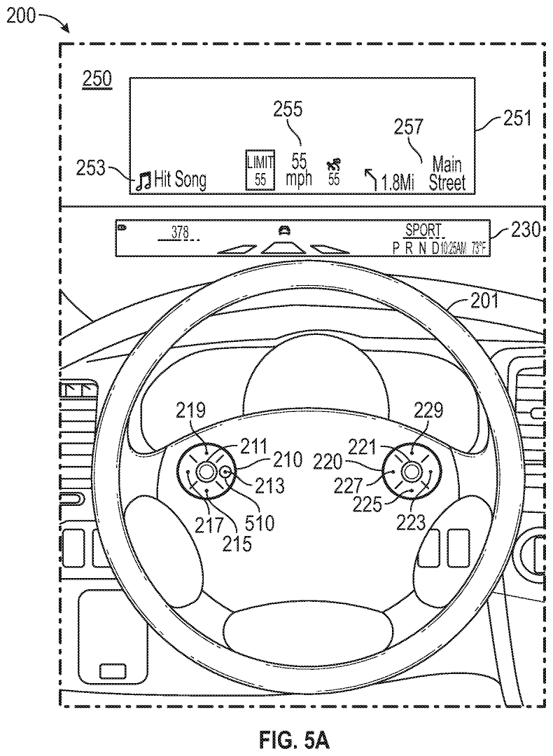

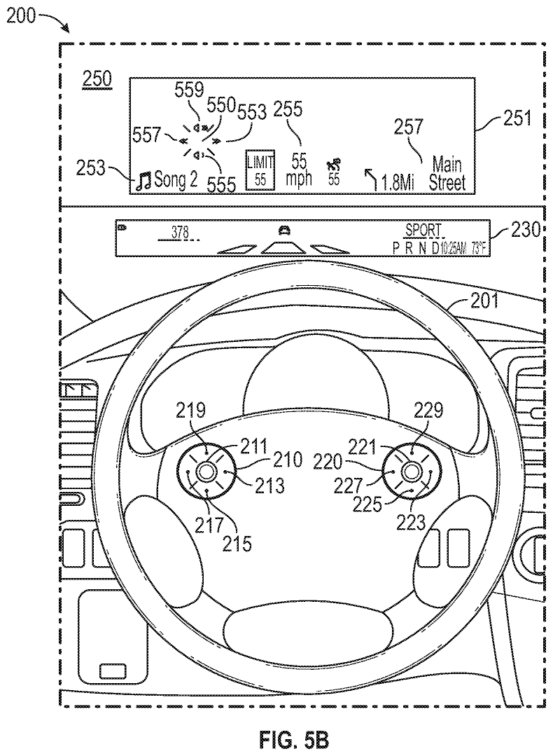

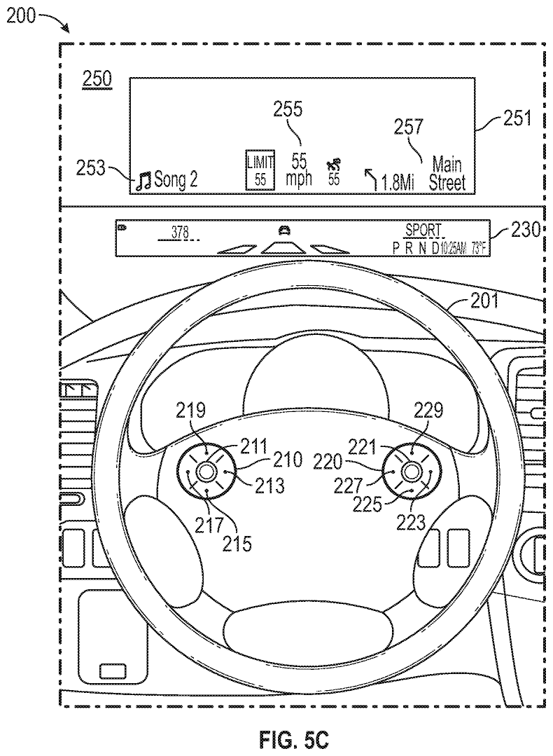

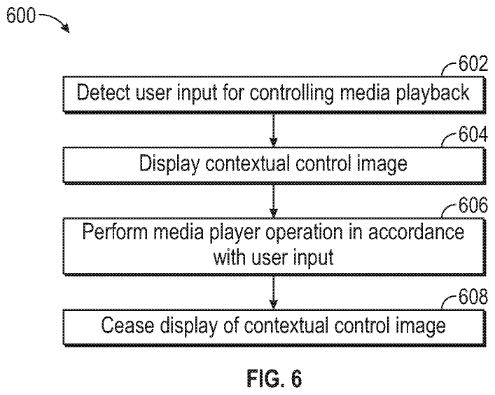

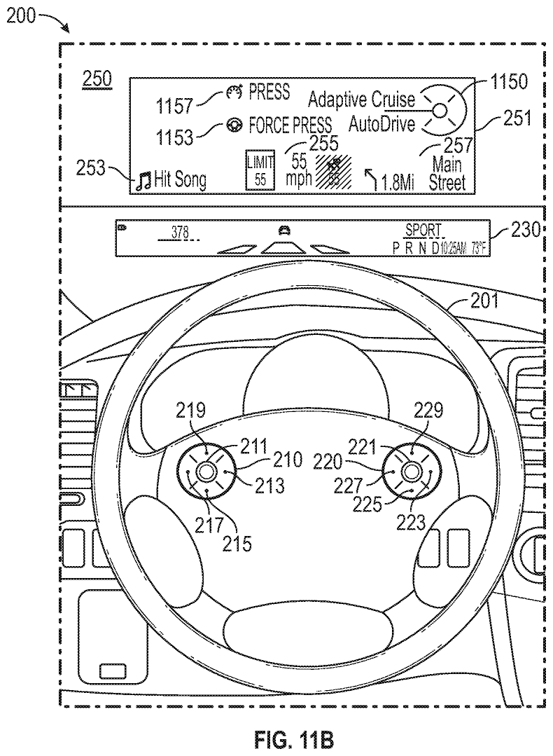

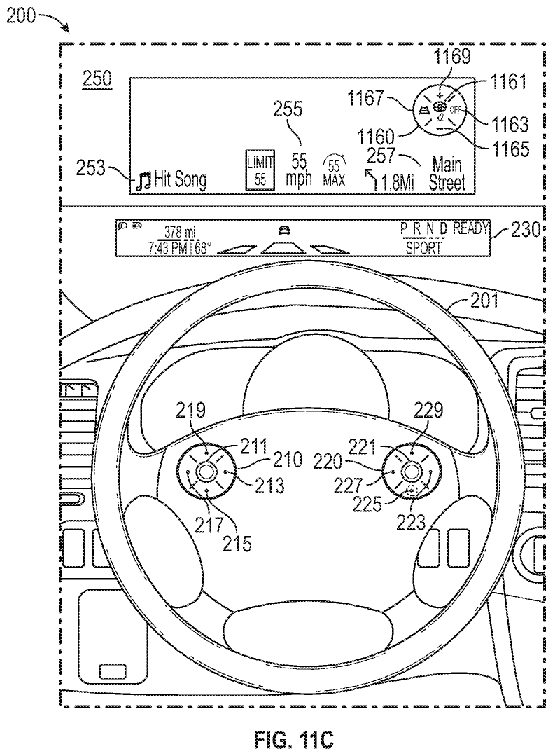

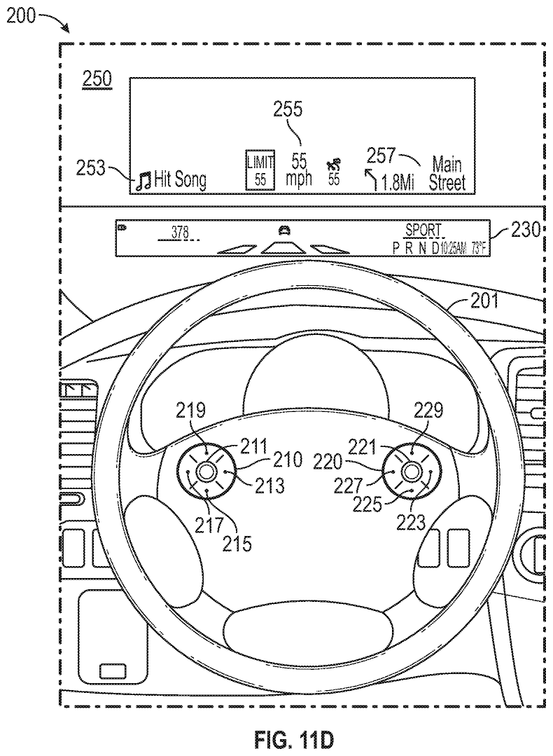

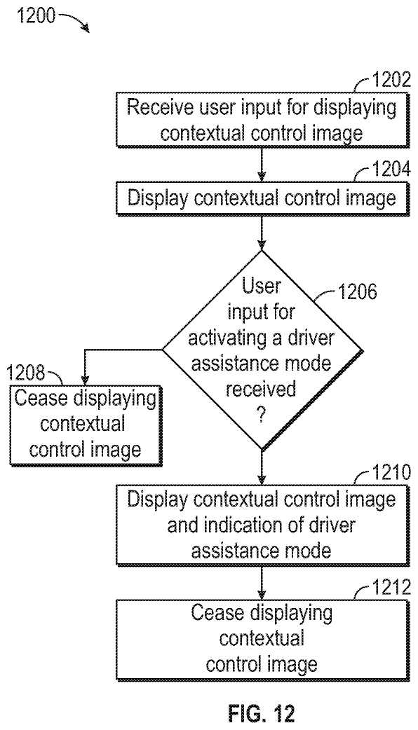

In some embodiments, touch pad 210 or 220 are associated with default operations when the vehicle is not performing an operation—such as receiving or participating in a phone call, receiving an alert, navigating a menu, repositioning one or more components, or other situations that use one or both touch pads 210 or 220 to receive user input—that causes the touch pads 210 and 220 to be reconfigured. Touch pad 210 optionally controls media content (e.g., accepts inputs for increasing the volume, decreasing the volume, skipping backwards, or skipping ahead) playing on a speaker (e.g., speaker 141) and/or controls a voice input user interface (e.g., digital assistant) of the vehicle by default, as will be described in more detail below with reference to FIGS. 5A-5C and 6. Touch pad 220 optionally controls one or more driver assistance features, such as adaptive cruise control (ACC) and a level-two or level-three autonomous driving mode (e.g., “Auto Drive” or some other mode that combines ACC with steering to keep the vehicle within a current lane on the road) by default, as will be described in more detail below with reference to FIGS. 11A-11D and 12. In some embodiments, the HUD does not display contextual control images indicative of the default operations, or only displays them in response to receiving a user input for performing one of the default operations.

FIGS. 3A-3C illustrate operation of a vehicle 200 when receiving a phone call and during a phone call according to examples of the disclosure. As shown in FIG. 3A, prior to receiving an indication of an incoming phone call at a mobile phone in communication with the vehicle 200, the HUD 251 displays media control information 253, cruise control information 255, and navigation information 257. Although touch pads 210 and 220 are configured to accept user input for default operations, such as media control operations, digital assistant operations, and driver assistance operations, the HUD 251 optionally does not display a contextual control image in the default state.

FIG. 3B illustrates operation of vehicle 200 at a time when a phone call is received. In response to receiving the indication of the incoming call (e.g., at a mobile phone in communication with the vehicle 200), the HUD optionally presents a visual indication of the incoming phone call 301 and a contextual control image 350 indicating the operations associated with the touch pad 210 in the context of the incoming phone call. As shown in the figure, the visual indication of the incoming call 301 optionally includes an indication of the name of the contact that is initiating the call. The contextual control image 350 optionally includes an image 353 indicating an operation for answering the phone call and an image 357 indicating an operation for declining the phone call. The operation for answering the phone call is optionally associated with the right input region 213 of the touch pad 210 and the operation for declining the phone call is optionally associated with the left input region 217 of the touch pad 210. As shown in the figure, the user optionally enters an input 310 at the right input region 213 of the touch pad 210 for answering the call. In response to the input 310, a controller of the vehicle optionally transmits a signal to the mobile phone to answer the phone call. Other operations and configurations are possible.

FIG. 3C illustrates operation of vehicle 200 during a phone call. In response to receiving the input for answering the phone call, the HUD optionally presents a visual indication of the phone call 303 and a contextual control image 360 indicating the operations associated with the touch pad 210 in the context of the phone call. As shown in the figure, the visual indication of the phone call 303 optionally includes an indication of the name of the contact that is on the phone call and an indication of the duration of the phone call. The contextual control image 360 optionally includes an image 363 indicating an operation for muting the phone call, an image 367 indicating an operation for ending the phone call, an image 365 indicating an operation for decreasing the volume of the phone call, and an image 369 indicating an operation for increasing the volume of the phone call. The operation for muting the phone call is optionally associated with a right input region 213 of the touch pad 210, the operation for ending the phone call is optionally associated with the left input region 217 of the touch pad 210, the operation for decreasing the volume of the phone call is optionally associated with the bottom region 215 of the touch pad, and the operation for increasing the volume of the phone call is optionally associated with the top region 219 of the touch pad 210. Other operations and configurations are possible.

FIG. 4 illustrates a process for performing phone call operations at vehicle 200 according to examples of the disclosure. Vehicle 200 optionally receives 402 an indication of an incoming phone call, as shown in FIG. 3B. In some embodiments, the phone call is received at a mobile phone in communication with the vehicle. In response to receiving the indication of the incoming phone call, the vehicle 200 optionally displays 404, on the HUD 251, an indication of the incoming phone call and a contextual control image, as shown in FIG. 3B. In some embodiments, the contextual control image includes an image of touch pad 210 and images indicating one or more operations related to the incoming phone call (e.g., accept call, decline call).

If the vehicle 200 does not detect 406 a valid user input (e.g., an input at an input region of the touch pad 210 associated with one of the operations related to the incoming phone call), after some amount of time (e.g., a predetermined amount of time (e.g., 2 seconds, 5 seconds, etc.) or when the incoming call ceases (e.g., the call goes to voicemail or the caller hangs up)) the vehicle 200 ceases 408 to display the indication of the incoming call and the contextual control image.

If the vehicle 200 detects 410 a user input for declining the call (e.g., an input at the left input region 217 of the touch pad 210, as shown in FIG. 3B), the phone call is not initiated and the vehicle ceases 408 to display the indication of the incoming call and the contextual control image.

If the vehicle 200 detects 412 a user input for accepting the call (e.g., an input at the right input region 213 of the touch pad 210, as shown in FIG. 3B), the phone call is initiated. While the phone call is in progress, the display optionally presents a visual indication of the phone call 303 and a contextual control image 360 indicating a plurality of operations related to the ongoing phone call that the user is able to perform using the touch pad 210 (e.g., mute call, end call, increase volume, and decrease volume), as shown in FIG. 3C.

FIGS. 5A-5C illustrate media player control operations of a vehicle 200 according to examples of the disclosure. As shown in FIG. 5A, prior to receiving a user input (e.g., via the first touchpad 210) for controlling a media player operating at one or more processors of the vehicle 200, the HUD 251 displays media control information 253, cruise control information 255, and navigation information 257. Although touch pads 210 and 220 are configured to accept user input for default operations, such as media control operations, digital assistant operations, and driver assistance operations, the HUD 251 optionally does not display a contextual control image in the default state. In some embodiments, a user input comprising a press of the center input region 211 of touch pad 210 causes the sound system of the vehicle to be muted or, if the sound system is already muted, un-muted. In some embodiments, a user input comprising a long press or a force press of the center input region 211 of touch pad 210 causes a vehicle digital assistant to be activated to accept a voice input for performing an action with the vehicle.

As shown in FIG. 5A, the vehicle 200 optionally detects a user input 510 at the right input region 213 of the first touchpad 210. In some embodiments, in response to the detected input 510, the media player of the vehicle 200 skips ahead to another song or item of audio content. In some embodiments, in response to the detected input 510, the vehicle 200 initially does not perform the skip ahead operation while there is no contextual control image displayed on HUD 251, and instead, in response to the input 510, displays a contextual control image as will be described below. While the contextual control image is being the displayed, the vehicle 200 optionally accepts user inputs for controlling the media player.

FIG. 5B illustrates operation of vehicle 200 after detecting the user input 510 for advancing the media player to the next item of content. In response to the user input 510, in some embodiments, the media player optionally skips ahead to the next item of audio content (e.g., “Song 2”), the HUD 251 optionally updates the media control information 253 to indicate the item of content that is now playing in response to the received input 510 (e.g., the media player is now playing “Song 2” after having advanced past “Hit Song”) and the HUD 251 also concurrently displays a contextual control image 550 indicating the operations associated with the touch pad 210 in the context of controlling the media player. In some embodiments, as described above, in response to detecting the user input 251 while there is no contextual control image displayed on the HUD 251, the vehicle 200 displays the contextual control image 550 without advancing the media player to skip ahead. The vehicle 200 optionally accepts user inputs to control the media player while the contextual control image 550 is displayed.

As shown in FIG. 5B, the contextual control image 550 optionally includes an image 553 indicating an operation for skipping ahead, an image 557 indicating an operation for skipping backwards, an image 555 indicating an operation for decreasing the playback volume, and an image 559 indicating an operation for increasing the playback volume. The operation for skipping ahead is optionally associated with a right input region 213 of the touch pad 210, the operation for skipping backwards is optionally associated with the left input region 217 of the touch pad 210, the operation for decreasing the playback volume is optionally associated with the bottom region 215 of the touch pad, and the operation for increasing the playback volume is optionally associated with the top region 219 of the touch pad 210. Other operations and configurations are possible.

FIG. 5C illustrates operation of vehicle 200 after a predetermined amount of time has passed since an input has been detected at the first touchpad 210. After the predetermined amount of time (e.g., 3 seconds, 5 seconds, or some other predetermined or user-defined time) has passed since the vehicle 200 detects an input at the first touchpad 210, the HUD 251 optionally ceases to display the contextual control image 550 illustrated in FIG. 5B. In some embodiments, at this time, the HUD 251 continues to display media control information 253, cruise control information 255, and navigation information 257.

FIG. 6 illustrates a process 600 for performing media control operations at vehicle 200 according to examples of the disclosure. Vehicle 200 optionally detects 602 a user input at the first touchpad 210 (e.g., for performing a media controller operation, such as a skip forward operation), as shown in FIG. 2A. In response to detecting the user input, the vehicle optionally displays, on the HUD 251, a contextual control image indicating a number of media control operations that the vehicle 200 is able to perform in response to further input at the first touchpad 210, as illustrated in FIG. 5B. The contextual control image 550 optionally includes an image of touch pad 210 and images indicating one or more operations related to media player controls (e.g., skip forward, skip backwards, increase playback volume, decrease playback volume). In some embodiments, the vehicle 200 also performs 606 the media player operation in response to the user input detected prior to displaying the contextual control image 550 on the HUD 251, though in some embodiments, the vehicle 200 performs 606 the media player operation in response to a subsequent user input detected while the contextual control image 550 is displayed on the HUD 251. After a predetermined amount of time passes after receiving the last input at the first touchpad 210, the vehicle 200 optionally ceases to display, on the HUD 251, the contextual control image 550, as shown in FIG. 5C.

FIGS. 7A-7B illustrate operation of a vehicle 200 while adjusting a vehicle 200 setting according to examples of the disclosure. As shown in FIG. 7A, the HUD 251 cruise control information 255, navigation information 257, and a vehicle control menu 710. In some embodiments, the vehicle control menu 710 is presented in response to a user input (e.g., a voice command, a selection of a button or soft button on the center console, etc.). For example, the user optionally enters an input at the center input region 211 comprising a force press or a long press for activating a vehicle digital assistant prior to the vehicle displaying, on the HUD 251, the vehicle control menu 710. Next, the user is able to speak a voice command to the vehicle digital assistant for presenting the vehicle control menu, such as “Adjust Steering Wheel” or “Display Vehicle Control Settings.” In response to the voice command, the vehicle digital assistant optionally causes the vehcle to display, on the HUD 251, the vehicle control menu 710.

Vehicle control menu 710 optionally includes a selected item 712 (e.g., “Steering wheel”). While vehicle control menu 710 is displayed on the HUD 251, touch pad 210 is optionally configured to accept user input for navigating the menu. For example, an operation for selecting a menu item is optionally associated with a right input region 213 of the touch pad 210, an operation for moving backwards in the menu hierarchy is optionally associated with the left input region 217 of the touch pad 210, an operation for scrolling down is optionally associated with the bottom region 215 of the touch pad, and an operation for scrolling up is optionally associated with the top region 219 of the touch pad 210. Other operations and configurations are possible. As shown in FIG. 7B, the user enters an input at the right input region 213 of the first touchpad 210 to select “steering wheel”. In response to the user input, the vehicle 200 enters a steering wheel adjustment mode, as will be described below with reference to FIG. 7B.

FIG. 7B illustrates operation of vehicle 200 to adjust one of the vehicle 200 components. In response to selection of the “Steering wheel” item in the vehicle control menu 710, the HUD 251 optionally presents a visual indication of the steering wheel adjustment mode 720 and a contextual control image 750 indicating the operations associated with the touch pad 210 in the context of adjusting the steering wheel. As shown in the figure, the visual indication of the steering wheel adjustment mode 720 optionally includes an indication instructing the user to use the touch pad to adjust the steering wheel position. The contextual control image 750 optionally includes an image 751 indicating an operation for confirming the position of the steering wheel, an image 753 indicating an operation for moving the steering wheel to the right, an image 755 indicating an operation for moving the steering wheel down, an image 757 indicating an operation for moving the steering wheel to the left and an image 759 indicating an operation for moving the steering wheel up. The operation for confirming the position of the steering wheel is optionally associated with a center input region 211 of the touch pad 210, the operation for moving the steering wheel to the right is optionally associated with a right input region 213 of the touch pad 210, the operation for moving the steering wheel to the left is optionally associated with the left input region 217 of the touch pad 210, the operation for moving the steering wheel down is optionally associated with the bottom region 215 of the touch pad, and the operation for moving the steering wheel up is optionally associated with the top region 219 of the touch pad 210. In some embodiments, during the steering wheel adjustment mode, a center display 270 of the vehicle 200 displays an image 271 indicating that the user can adjust the steering wheel 201 using the touch pad 210. The user is optionally able to navigate a vehicle control menu displayed on the center display 270 to select the steering wheel adjustment mode prior to adjusting the steering wheel 201.

Other operations and configurations are possible. For example, other vehicle 200 components, such as one or more mirrors or camera-simulated mirrors (e.g., side mirrors or side cameras, rear view mirror or camera), one or more seats (e.g., the driver's seat, the passenger's seat, or one or more back seats), and other components can be adjusted in a similar manner using the touch pad 210. Other settings, such as display (e.g., HUD 251, instrument cluster 230, etc.) brightness, climate control, clock, and audio playback (e.g., volume, balance, fade, bass, etc.) can also be adjusted by navigating the vehicle control menu 710 and operating the touch pad 210.

FIG. 8 illustrates a process 800 for performing vehicle settings operations at vehicle 200 according to examples of the disclosure. Vehicle 200 optionally receives 802 an input (e.g., a voice input, selection of a button or switch, input received at center display 270, etc.) for displaying the vehicle control menu 710. In response to receiving the input, the vehicle 200 optionally displays, on the HUD 251, a vehicle control menu 710, as shown in FIG. 7A. While displaying the vehicle control menu 710, the vehicle 200 optionally receives 806 an input (e.g., at touch pad 210) selecting, from the menu, a menu item to modify (e.g., the steering wheel position), as shown in FIG. 7A. In response to the selection, the vehicle displays a contextual control image 750 indicating a plurality of operations for adjusting the vehicle setting, as shown in FIG. 7B. In some embodiments, the contextual control image includes an image of touch pad 210 and images indicating one or more operations related to the vehicle setting (e.g., confirm steering wheel position, move steering wheel to the right, move steering wheel to the left, move steering wheel up, move steering wheel down). The vehicle 200 optionally modifies 810 the selected menu item (e.g., steering wheel position) in accordance with further input detected at the touch pad 210. Although the examples described with reference to FIGS. 7A-7B and 8 relate to adjusting the position of the steering wheel, it should be understood that other vehicle settings, as discussed above, can be modified in a similar manner without departing from the scope of the disclosure.

FIGS. 9A-9C illustrate operation of a vehicle 200 when a warning is generated by the vehicle 200 according to examples of the disclosure. As shown in FIG. 9A, prior to the generation of the alert, the HUD 251 displays media control information 253, cruise control information 255, and navigation information 257. Although touch pads 210 and 220 are configured to accept user input for default operations, such as media control operations, digital assistant operations, and driver assistance operations, the HUD optionally does not display a contextual control image in the default state.

FIG. 9B illustrates operation of vehicle 200 at a time when a vehicle warning is generated. In response to generating the vehicle warning, the instrument cluster 230 optionally presents a telltale 920 indicating the vehicle warning and the HUD optionally presents a visual indication 910 of the vehicle warning and a contextual control image 950 indicating the operations associated with the touch pad 210 in the context of the vehicle warning. As shown in the figure, the visual indication 910 of the vehicle warning optionally includes an image and text indicating the event that triggered the warning (e.g., “ABS Failure”) and instructions on how to proceed (e.g., “Contact Service Center Immediately”). The contextual control image 950 optionally includes an image 951 indicating an operation for dismissing the warning. The operation for dismissing the warning is optionally associated with the center input region 211 of the touch pad 210. Other operations and configurations are possible.

FIG. 9C illustrates operation of vehicle 200 after the vehicle warning is dismissed. In some embodiments, the vehicle warning is dismissed in response to a user input (e.g., an input at the center region 211 of the touch pad 210) or after a predetermined amount of time has passed (e.g., 2 seconds, 5 seconds, another predetermined time, or a user-defined period of time). In response to the dismissal of the vehicle warning, the HUD 251 ceases to display the indication of the vehicle warning 910 and the contextual control image 950. In some embodiments, the instrument cluster 230 continues to present the telltale 920 after the vehicle warning is dismissed. The telltale 920 optionally persists until the trigger of the vehicle warning (e.g., the ABS failure) is resolved or until the user or a mechanic performs some other procedure for removing the telltale 920 (e.g., turning off the telltale from a settings menu or pressing a button for resetting the instrument cluster).

FIG. 10 illustrates a process 1000 for presenting and dismissing a vehicle warning at vehicle 200 according to examples of the disclosure. Vehicle 200 optionally receives 1002 an indication of a vehicle warning. In response to receiving the indication of the vehicle warning, the vehicle 200 optionally displays, on the HUD 251, an indication of the vehicle warning 910 and a contextual control image 950, as shown in FIG. 9B. In some embodiments, the contextual control image includes an image of touch pad 210 and images indicating one or more operations related to the vehicle warning (e.g., to dismiss the warning). In some embodiments, in response to receiving the indication of the vehicle warning, the vehicle 200 also displays, on the instrument cluster 230, a telltale 920 indicating the vehicle warning, as shown in FIG. 9B. Optionally, the vehicle receives 1006 an input (e.g., via touchpad 210) for dismissing the vehicle warning. In response to the input for dismissing the vehicle warning, the vehicle ceases 1008 to display the indication of the vehicle warning 910 and the contextual control image 950. In some embodiments, the vehicle does not detect an input for dismissing the vehicle warning and ceases to display the indication of the vehicle warning 910 and the contextual control image 950 after a predetermined amount of time has passed (e.g., 2 seconds, 5 seconds, some other predetermined amount of time, a user-defined amount of time, etc.).

FIGS. 11A-D illustrate operation of a vehicle 200 when performing driver assistance functions according to examples of the disclosure. In some embodiments, driver assistance functions can include cruise control, adaptive cruise control, lane departure prevention (e.g., “AutoDrive”), and other autonomous and semi-autonomous driving functions. As shown in FIG. 11A prior to performing a driver assistance function, the HUD 251 displays media control information 253, cruise control information 255, and navigation information 257. In some embodiments, the cruise control information 255 includes a dimmed cruise control speed indicator 1110, indicating that the vehicle is not currently operating with the cruise control activated. Although touch pads 210 and 220 are configured to accept user input for default operations, such as media control operations, digital assistant operations, and driver assistance operations, the HUD optionally does not display a contextual control image in the default state.

FIG. 11B illustrates operation of vehicle 200 at a time when a user input has been received for activating a driver assistance function. In some embodiments, the user input is received at a center input region 221 of touchpad 220. In response to the user input, the HUD 251 optionally presents a contextual control image 1150 indicating the operations associated with the touch pad 220 in the context of driver assistance functions. The contextual control image 950 optionally includes an image 1157 indicating an operation for activating adaptive cruise control and an image 1153 indicating an operation for activating a lane departure prevention mode (e.g., “AutoDrive”). The operation for activating adaptive cruise control is optionally associated with a press of the center region 221 of the touch pad 210 and the operation for activating AutoDrive is optionally associated with a force press (e.g., a press having a duration longer than a threshold amount of time, being pressed with an amount of force exceeding a predetermined force threshold, or another characteristic) at the center input region 211 of the touch pad 210. Other operations and configurations are possible.

FIG. 11C illustrates operation of vehicle 200 during a driver assistance function. As shown in FIG. 11C, the vehicle 200 is operating with adaptive cruise control activated. In some embodiments, adaptive cruise control is activated in response to receiving a press at the center input region 221 of touchpad 220 while the contextual control image 1150 is displayed on the HUD 251, as described above with reference to FIG. 11B. In response to the input for activating the adaptive cruise control, the HUD optionally presents a visual indication of cruise control 255 with a non-dimmed appearance and a contextual control image 1160 indicating the operations associated with the touch pad 220 in the context of adaptive cruise control. The contextual control image 1160 optionally includes an image 1161 indicating an operation for activating the “AutoDrive” mode, an image 1163 indicating an operation for ceasing the driver assistance function (e.g., Cruise control or “AutoDrive” mode, whichever is active), an image 1167 indicating an operation for altering the following distance, an image 1165 indicating an operation for decreasing maximum speed, and an image 1169 indicating an operation for increasing maximum speed. The operation for activating the “AutoDrive” mode is optionally associated with a center input region 221 of the touch pad 220, the operation for ceasing the driver assistance function is optionally associated with a right input region 223 of the touch pad 220, the operation for altering the following distance is optionally associated with the left input region 227 of the touch pad 220, the operation for decreasing maximum speed is optionally associated with the bottom region 225 of the touch pad 220, and the operation for increasing maximum speed is optionally associated with the top region 229 of the touch pad 220. In some embodiments, in response to a user input received at the left input region 227 of the touch pad 220, the vehicle updates the following distance to be one of a plurality of predetermined following distances available to the vehicle. For example, if there are four predetermined following distances and the vehicle is currently set at a first following distance, in response to a user input for altering the vehicle following distance, the vehicle updates the following distance to be the second following distance and so on. Other operations and configurations are possible.

In some embodiments, after a predetermined amount of time has passed since the last user input at touchpad 220, the vehicle ceases to display the contextual control image 1160 while remaining in the adaptive cruise control mode, as shown in FIG. 11D. The vehicle optionally presents the contextual control image 1160 in response to further input received at the touchpad 220. In some embodiments, the vehicle does not make adjustments to the adaptive cruise control in response to an input received at the touchpad 220 while the contextual control image 1160 is not displayed to avoid accidental changes made by the user. In some embodiments, however, the vehicle performs the respective operations associated with the input regions of the touchpad 220 even when the contextual control image 1160 is not displayed to reduce the number of user inputs necessary for modifying the adaptive cruise control.

FIG. 12 illustrates a process 1200 for performing driver assistance operations at vehicle 200 according to examples of the disclosure. Vehicle 200 optionally receives 1202 an input (e.g., at touchpad 220) for displaying a contextual control image 1150 associated with driver assistance operations. In response to the user input, the vehicle optionally displays the contextual control image 1150 on the HUD 251. In some embodiments, the contextual control image 1150 includes an image of touch pad 220 and images indicating one or more operations related to driver assistance functions (e.g., adaptive cruise control, AutoDrive).

If the vehicle 200 does not detect 1206 a valid user input (e.g., an input at an input region of the touch pad 220 associated with one of the operations related to the driver assistance operations) after some amount of time (e.g., 2 seconds, 5 seconds, etc.) the vehicle 200 ceases 1208 to display the contextual control image 1150.

If the vehicle 200 detects 1206 a valid user input, the vehicle 200 determines which input region of the touch pad 210 detected the user input and whether the input matches a predetermined characteristic (e.g., a press, a force press, etc.), and performs the operation in accordance with the input region where the input was detected and characteristic of the input. For example, if the vehicle detects a press at the center input region 221 of the touchpad 220, adaptive cruise control is optionally activated and if the vehicle detects a force press at the center input region 221 of the touchpad 220, AutoDrive is optionally activated. After activating the respective driver assistance function, the vehicle 200 displays 1210, on the HUD a contextual control image 1160, as shown in FIG. 11C. In some embodiments, the contextual control image 1160 includes an image of touch pad 220 and images indicating one or more operations related to the driver assistance operation (e.g., increase following distance, decrease following distance, decrease maximum speed, increase maximum speed).

In some embodiments, when a user input at touch pad 210 or 220 is received while the contextual control image is not displayed, the vehicle 200 optionally displays the contextual control image without performing the associated operation. If the vehicle 200 detects a user input while the contextual control image is displayed, the vehicle optionally performs the associated operation. In other words, in some embodiments, the user enters a first user input at the touch pad 210 or 220 to present the contextual control image without performing the associated operation and can cause the vehicle 200 to perform a further operation in response to a user input received at the touch pad 210 or 220 while the contextual control image is being displayed. This manner of forgoing performing operations in response to the touch pad 210 or 220 unless the contextual control image is displayed prevents accidental user inputs.

In some embodiments, the vehicle 200 performs the associated operation in response to an input at the touch pad 210 or 220 even when no contextual control image is being displayed. This manner of performing the operation in response to the touch pad 210 or 220 in the absence of the contextual control image reduces the number of user inputs required to perform an operation using the touch pad 210 or 220.

In some embodiments, the user is able to select a vehicle setting to control whether or not the vehicle 200 performs an operation associated with the touch pad 210 or 220 when a user input is received at the touch pad 210 or 220 while the contextual control image is not displayed. These settings can optionally be set differently for each type of vehicle operation that can be controlled at touch pad 210 or 220. For example, the user may prefer to require two inputs to activate ACC, but may wish to be able to control the media player with one input.

Therefore, according to the above, some embodiments of the disclosure are related to a vehicle comprising:a first touch pad comprising a plurality of input regions; a heads-up display (HUD), the HUD comprising a projector and a windshield of the vehicle; one or more processors operatively coupled to the first touch pad and the HUD; a memory including instructions, which when executed by the one or more processors, cause the one or more processors to perform a method comprising: receiving an indication of a first user input at an input region of the first touch pad; in response to receiving the indication of the first user input, performing a first operation in accordance with the input region of the first touch pad; performing a second operation; in response to the second operation, displaying, on the HUD, a first contextual control image, the first contextual control image comprising a representation of the first touch pad and an image indicating a third operation associated with the first input region of the first touch pad, the third operation different from the first operation; receiving an indication of a second user input at the first input region of the first touch pad; and in response to receiving the indication of the second user input, performing the third operation in accordance with the input region of the first touch pad. Additionally or alternatively, in some embodiments, the method further comprises: receiving an indication of an incoming phone call, in response to receiving the indication of the incoming phone call, displaying, on the HUD, a second contextual control image comprising an image indicating an answering operation and an image indicating a declining operation, wherein the image indicating a respective one of the answering operation and the declining operation is visually associated with a respective input region of the first touch pad, receiving an indication of a third user input at the respective input region of the first touch pad, and in response to the third user input, performing the respective one of the answering operation and the declining operation in accordance with the respective input region of the first touch pad. Additionally or alternatively, in some embodiments, the method further comprises: during a phone call of a phone operatively coupled to the one or more processors: displaying, on the HUD, a second contextual control image comprising an image indicating a volume up operation, an image indicating a volume down operation, an image indicating a mute call operation, and an image indicating an end call operation, wherein the image indicating a respective one of the volume up operation, the volume down operation, the mute call operation, and the end call operation is visually associated with a respective input region of the first touch pad, receiving an indication of a third user input at the respective input region of the first touch pad, and in response to the third user input, performing the respective one of the volume up operation, the volume down operation, the mute call operation, and the end call operation in accordance with the respective input region of the first touch pad. Additionally or alternatively, in some embodiments, the method further comprises: while playing audio content on a speaker operatively coupled to the one or more processors: receiving an indication of a third user input at a respective input region of the first touch pad, and in response to the third user input, performing a respective operation associated with the respective input region of the first touch pad, the respective operation being one of a volume up operation, a volume down operation, a skip ahead operation, a skip backwards operation, wherein the HUD does not display an image indicating the volume up operation, an image indicating the volume down operation, an image indicating the skip ahead operation, an image indicating the, or an image indicating the skip backwards operation while the indication of the third user input is received. Additionally or alternatively, in some embodiments, the method further comprises: displaying, on the HUD, a plurality of menu items, each menu item associated with a setting of the vehicle, while displaying the plurality of menu items, receiving an indication of a third user input at a respective input region of the first touch pad, and in response to the third user input, performing a respective operation associated with the respective input region of the first touch pad, the respective operation being one of a scrolling operation, a navigate backwards operation, and a selection operation. Additionally or alternatively, in some embodiments, the method further comprises: receiving a third user input for adjusting a position of a component of the vehicle, the component being one of a steering wheel, a mirror, and a seat, in response to receiving the third user input, displaying, on the HUD, a second contextual image comprising an image indicating a first adjustment operation on the component of the vehicle, an image indicating a second adjustment operation on the component of the vehicle, and an image indicating a confirm operation, wherein the image indicating a respective one of the first adjustment operation, the second adjustment operation, and the confirm operation is visually associated with a respective input region of the first touch pad, receiving an indication of a fourth use input at the respective input region of the first touch pad, and in response to the fourth user input, performing the respective one of the first adjustment operation, the second adjustment operation, and the confirm operation in accordance with the respective input region of the first touch pad. Additionally or alternatively, in some embodiments, the vehicle further comprises a second display, and the method further comprises: receiving an indication of a vehicle warning, in response to receiving the indication of the vehicle warning: displaying, on the second display, a first visual indication of the vehicle warning, and concurrently displaying, on the HUD, a second visual indication of the vehicle warning and a second contextual control image comprising an image indicating a dismiss operation, wherein the image indicating the dismiss operation is visually associated with a respective input region of the first touch pad, receiving an indication of a third user input at the respective input region of the first touch pad, and in response to the third user input, ceasing to display the second visual indication of the vehicle warning and the second contextual control image without ceasing to display the first indication of the vehicle warning. Additionally or alternatively, in some embodiments, the vehicle further comprises a second touch pad comprising a plurality of input regions, wherein the method further comprises: receiving an indication of a third user input at an input region of the second touch pad, in response to receiving the indication of the third user input, displaying, on the HUD, a second contextual control image comprising a representation of the second touch pad and an image indicating a first driver assistance function and an image indicating a second driver assistance function, wherein a respective one of the first driver assistance function and the second driver assistance function is associated with a first characteristic of an input at the input region of the second touch pad, receiving an indication of a fourth user input at the input region of the second touch pad, the fourth user input having the first characteristic, and in response to receiving the fourth user input, performing the respective one of the first driver assistance function and the second driver assistance function in accordance with the first characteristic of the fourth user input. Additionally or alternatively, in some embodiments, in response to receiving the fourth user input: the vehicle enters an adaptive cruise control driving mode in accordance with the first characteristic of the fourth user input, and the method further comprises: displaying, on the HUD, a third contextual control image comprising a representation of the second touch pad and an image indicating an increase speed operation, an image indicating a decrease speed operation, an image indicating an increase following distance operation, and an image indicating a decrease following distance operation, wherein the image indicating a respective one of the increase speed operation, the decrease speed operation, the increase following distance operation, and the decrease following distance operation is visually associated with a respective input region of the second touch pad, receiving an indication of a fifth user input at the respective input region of the second touch pad, and in response to the fifth user input, performing the respective one of the increase speed operation, the decrease speed operation, the increase following distance operation, and the decrease following distance operation in accordance with the respective input region of the second touch pad.

Therefore, according to the above, some embodiments of the disclosure are related to a vehicle comprising: a first touch pad comprising a plurality of input regions; a heads-up display (HUD), the HUD comprising a projector and a windshield of the vehicle; one or more processors operatively coupled to the first touch pad and the HUD; a memory including instructions, which when executed by the one or more processors, cause the one or more processors to perform a method comprising: receiving an indication of a first user input at a first input region of the first touch pad; in response to receiving the indication of the first user input, performing a first operation in accordance with the first input region of the first touch pad; performing a second operation; in response to the second operation, displaying, on the HUD, a first contextual control image, the first contextual control image comprising a representation of the first touch pad and an image indicating a third operation associated with the first input region of the first touch pad, the third operation different from the first operation; receiving an indication of a second user input at the first input region of the first touch pad; and in response to receiving the indication of the second user input, performing the third operation in accordance with the input region of the first touch pad. Additionally or alternatively, in some embodiments, the second operation comprises receiving an indication of an incoming phone call, the first contextual control image comprises an image indicating an answering operation and an image indicating a declining operation, wherein the image indicating a respective one of the answering operation and the declining operation is visually associated with the first input region of the first touch pad, and the first operation is different than receiving the indication of the incoming phone call. Additionally or alternatively, in some embodiments, the second operation comprises executing a phone call of a phone operatively coupled to the one or more processors, during the phone call, the first contextual control image comprises an image indicating a volume up operation, an image indicating a volume down operation, an image indicating a mute call operation, and an image indicating an end call operation, wherein the image indicating a respective one of the volume up operation, the volume down operation, the mute call operation, and the end call operation is visually associated with the first input region of the first touch pad, and the first operation is different than executing the phone call. Additionally or alternatively, in some embodiments, the first operation comprises one of a skip ahead operation of audio content playing on a speaker operatively coupled to the one or more processors, a skip backwards operation of the audio content playing on the speaker, a volume up operation, and a volume down operation, and the HUD does not display an image indicating the volume up operation, an image indicating the volume down operation, an image indicating the skip ahead operation, or an image indicating the skip backwards operation while the indication of the first user input is received. Additionally or alternatively, in some embodiments, the second operation comprises displaying, on the HUD, a plurality of menu items, each menu item associated with a setting of the vehicle, the first contextual control image comprises an image indicating a scrolling operation, an image indicating a navigate backwards operation, and an image indicating a selection operation, wherein the image indicating a respective one of the scrolling operation, the navigate backwards operation, and the selection operation is visually associated with the first input region of the first touch pad, and the first operation is different than displaying, on the HUD, the plurality of menu items. Additionally or alternatively, in some embodiments, the second operation comprises adjusting a position of a component of the vehicle, the component being one of a steering wheel, a mirror, and a seat, the first contextual image comprises an image indicating a first adjustment operation on the component of the vehicle, an image indicating a second adjustment operation on the component of the vehicle, and an image indicating a confirm operation, wherein the image indicating a respective one of the first adjustment operation, the second adjustment operation, and the confirm operation is visually associated with a respective input region of the first touch pad, and the first operation is different than adjusting the position of the component of the vehicle. Additionally or alternatively, in some embodiments, the vehicle further comprises a second display, wherein: the second operation comprises receiving an indication of a vehicle warning, in response to receiving the indication of the vehicle warning the vehicle displays, on the second display, a first visual indication of the vehicle warning, in response to receiving the indication of the vehicle warning, the vehicle concurrently displays, on the HUD, a second visual indication of the vehicle warning and the first contextual control image, the first contextual control image comprises an image indicating a dismiss operation, wherein the image indicating the dismiss operation is visually associated with the first input region of the first touch pad, in response to the second user input, the vehicle ceases to display the second visual indication of the vehicle warning and the first contextual control image while continuing to display the first indication of the vehicle warning, and the first operation is different than receiving the indication of the vehicle warning. Additionally or alternatively, in some embodiments, the vehicle further comprises a second touch pad comprising a plurality of input regions, wherein the method further comprises: receiving an indication of a third user input at an input region of the second touch pad, in response to receiving the indication of the third user input, displaying, on the HUD, a second contextual control image comprising a representation of the second touch pad and an image indicating a first driver assistance function and an image indicating a second driver assistance function, wherein a respective one of the first driver assistance function and the second driver assistance function is associated with a first characteristic of an input at the input region of the second touch pad, receiving an indication of a fourth user input at the input region of the second touch pad, the fourth user input having the first characteristic, and in response to receiving the fourth user input, performing the respective one of the first driver assistance function and the second driver assistance function in accordance with the first characteristic of the fourth user input. Additionally or alternatively, in some embodiments, in response to receiving the fourth user input: the vehicle enters an adaptive cruise control driving mode in accordance with the first characteristic of the fourth user input, and the method further comprises: displaying, on the HUD, a third contextual control image comprising a representation of the second touch pad and an image indicating an increase speed operation, an image indicating a decrease speed operation, an image indicating an alter following distance operation, an image indicating an initiate third driver assistance function operation, and an image indicating a cease adaptive cruise control driving mode operation, wherein the image indicating a respective one of the increase speed operation, the decrease speed operation, the alter following distance operation, the initiate driver assistance function operation, and the cease adaptive cruise control driving mode operation is visually associated with a respective input region of the second touch pad, receiving an indication of a fifth user input at the respective input region of the second touch pad, and in response to the fifth user input, performing the respective one of the increase speed operation, the decrease speed operation, the alter following distance operation, the initiate third driver assistance function operation, and the cease adaptive cruise control driving mode operation in accordance with the respective input region of the second touch pad.

Some embodiments of the disclosure are related to a non-transitory computer-readable medium including instructions, which when executed by one or more processors, cause the one or more processors to perform a method comprising: receiving an indication of a first user input at an input region of a first touch pad; in response to receiving the indication of the first user input, performing a first operation in accordance with the input region of the first touch pad; performing a second operation; in response to the second operation, displaying, on a heads-up display (HUD), a first contextual control image, the first contextual control image comprising a representation of the first touch pad and an image indicating a third operation associated with the first input region of the first touch pad, the third operation different from the first operation; receiving an indication of a second user input at the first input region of the first touch pad; and in response to receiving the indication of the second user input, performing the third operation in accordance with the input region of the first touch pad. Additionally or alternatively, in some embodiments, the second operation comprises receiving an indication of an incoming phone call, the first contextual control image comprises an image indicating an answering operation and an image indicating a declining operation, wherein the image indicating a respective one of the answering operation and the declining operation is visually associated with the first input region of the first touch pad, and the first operation is different than receiving the indication of the incoming phone call. Additionally or alternatively, in some embodiments, the second operation comprises executing a phone call of a phone operatively coupled to the one or more processors, during the phone call, the first contextual control image comprises an image indicating a volume up operation, an image indicating a volume down operation, an image indicating a mute call operation, and an image indicating an end call operation, wherein the image indicating a respective one of the volume up operation, the volume down operation, the mute call operation, and the end call operation is visually associated with the first input region of the first touch pad, and the first operation is different than executing the phone call. Additionally or alternatively, in some embodiments, wherein the vehicle further comprises a second display, wherein: the second operation comprises receiving an indication of a vehicle warning, in response to receiving the indication of the vehicle warning the vehicle displays, on the second display, a first visual indication of the vehicle warning, in response to receiving the indication of the vehicle warning, the vehicle concurrently displays, on the HUD, a second visual indication of the vehicle warning and the first contextual control image, the first contextual control image comprises an image indicating a dismiss operation, wherein the image indicating the dismiss operation is visually associated with the first input region of the first touch pad, in response to the second user input, the vehicle ceases to display the second visual indication of the vehicle warning and the first contextual control image while continuing to display the first indication of the vehicle warning, and the first operation is different than receiving the indication of the vehicle warning. Additionally or alternatively, in some embodiments, wherein the vehicle further comprises a second touch pad comprising a plurality of input regions, wherein the method further comprises: receiving an indication of a third user input at an input region of the second touch pad, in response to receiving the indication of the third user input, displaying, on the HUD, a second contextual control image comprising a representation of the second touch pad and an image indicating a first driver assistance function and an image indicating a second driver assistance function, wherein a respective one of the first driver assistance function and the second driver assistance function is associated with a first characteristic of an input at the input region of the second touch pad, receiving an indication of a fourth user input at the input region of the second touch pad, the fourth user input having the first characteristic, and in response to receiving the fourth user input, performing the respective one of the first driver assistance function and the second driver assistance function in accordance with the first characteristic of the fourth user input.

Some embodiments of the disclosure are related to a method comprising receiving an indication of a first user input at an input region of a first touch pad; in response to receiving the indication of the first user input, performing a first operation in accordance with the input region of the first touch pad; performing a second operation; in response to the second operation, displaying, on a heads-up display (HUD), a first contextual control image, the first contextual control image comprising a representation of the first touch pad and an image indicating a third operation associated with the first input region of the first touch pad, the third operation different from the first operation; receiving an indication of a second user input at the first input region of the first touch pad; and in response to receiving the indication of the second user input, performing the third operation in accordance with the input region of the first touch pad. Additionally or alternatively, in some embodiments, the second operation comprises receiving an indication of an incoming phone call, the first contextual control image comprises an image indicating an answering operation and an image indicating a declining operation, wherein the image indicating a respective one of the answering operation and the declining operation is visually associated with the first input region of the first touch pad, and the first operation is different than receiving the indication of the incoming phone call. Additionally or alternatively, in some embodiments, the second operation comprises executing a phone call of a phone operatively coupled to the one or more processors, during the phone call, the first contextual control image comprises an image indicating a volume up operation, an image indicating a volume down operation, an image indicating a mute call operation, and an image indicating an end call operation, wherein the image indicating a respective one of the volume up operation, the volume down operation, the mute call operation, and the end call operation is visually associated with the first input region of the first touch pad, and the first operation is different than executing the phone call. Additionally or alternatively, in some embodiments, the second operation comprises receiving an indication of a vehicle warning, in response to receiving the indication of the vehicle warning the vehicle displays, on the second display, a first visual indication of the vehicle warning, in response to receiving the indication of the vehicle warning, the vehicle concurrently displays, on the HUD, a second visual indication of the vehicle warning and the first contextual control image, the first contextual control image comprises an image indicating a dismiss operation, wherein the image indicating the dismiss operation is visually associated with the first input region of the first touch pad, in response to the second user input, the vehicle ceases to display the second visual indication of the vehicle warning and the first contextual control image while continuing to display the first indication of the vehicle warning, and the first operation is different than receiving the indication of the vehicle warning. Additionally or alternatively, in some embodiments, the vehicle further comprises a second touch pad comprising a plurality of input regions, wherein the method further comprises: receiving an indication of a third user input at an input region of the second touch pad, in response to receiving the indication of the third user input, displaying, on the HUD, a second contextual control image comprising a representation of the second touch pad and an image indicating a first driver assistance function and an image indicating a second driver assistance function, wherein a respective one of the first driver assistance function and the second driver assistance function is associated with a first characteristic of an input at the input region of the second touch pad, receiving an indication of a fourth user input at the input region of the second touch pad, the fourth user input having the first characteristic, and in response to receiving the fourth user input, performing the respective one of the first driver assistance function and the second driver assistance function in accordance with the first characteristic of the fourth user input.

Some embodiments of the disclosure are related to means for receiving an indication of a first user input at an input region of a first touch pad; means for performing a first operation in accordance with the input region of the first touch pad in response to receiving the indication of the first user input; means for performing a second operation; means for displaying, on a heads-up display (HUD), in response to the second operation, a first contextual control image, the first contextual control image comprising a representation of the first touch pad and an image indicating a third operation associated with the first input region of the first touch pad, the third operation different from the first operation; means for receiving an indication of a second user input at the first input region of the first touch pad; and means for performing the third operation in accordance with the input region of the first touch pad in response to receiving the indication of the second user input.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

What is claimed as new and desired to be protected by Letters Patent of the United States is:

1. A vehicle comprising:
a first touch pad comprising a plurality of input regions;
a heads-up display (HUD), the HUD comprising a projector and a windshield of the vehicle;
one or more processors operatively coupled to the first touch pad and the HUD;
a memory including instructions, which when executed by the one or more processors, cause the one or more processors to perform a method comprising:
receiving an indication of a first user input at a first input region of the first touch pad;
in response to receiving the indication of the first user input, performing a first operation in accordance with the first input region of the first touch pad;
performing a second operation;
in response to the second operation, displaying, on the HUD, a first contextual control image, the first contextual control image comprising a representation of the first touch pad and an image indicating a third operation associated with the first input region of the first touch pad, the third operation different from the first operation;
receiving an indication of a second user input at the first input region of the first touch pad; and
in response to receiving the indication of the second user input, performing the third operation in accordance with the input region of the first touch pad.

2. The vehicle of claim 1, wherein:
the second operation comprises receiving an indication of an incoming phone call,
the first contextual control image comprises an image indicating an answering operation and an image indicating a declining operation, wherein the image indicating a respective one of the answering operation and the declining operation is visually associated with the first input region of the first touch pad, and
the first operation is different than receiving the indication of the incoming phone call.

3. The vehicle of claim 1, wherein:
the second operation comprises executing a phone call of a phone operatively coupled to the one or more processors,
during the phone call, the first contextual control image comprises an image indicating a volume up operation, an image indicating a volume down operation, an image indicating a mute call operation, and an image indicating an end call operation, wherein the image indicating a respective one of the volume up operation, the volume down operation, the mute call operation, and the end call operation is visually associated with the first input region of the first touch pad, and
the first operation is different than executing the phone call.

4. The vehicle of claim 1, wherein:
the first operation comprises one of a skip ahead operation of audio content playing on a speaker operatively coupled to the one or more processors, a skip backwards operation of the audio content playing on the speaker, a volume up operation, and a volume down operation, and
the HUD does not display an image indicating the volume up operation, an image indicating the volume down operation, an image indicating the skip ahead operation, or an image indicating the skip backwards operation while the indication of the first user input is received.

5. The vehicle of claim 1, wherein:
the second operation comprises displaying, on the HUD, a plurality of menu items, each menu item associated with a setting of the vehicle,
the first contextual control image comprises an image indicating a scrolling operation, an image indicating a navigate backwards operation, and an image indicating a selection operation, wherein the image indicating a respective one of the scrolling operation, the navigate backwards operation, and the selection operation is visually associated with the first input region of the first touch pad, and
the first operation is different than displaying, on the HUD, the plurality of menu items.

6. The vehicle of claim 1, wherein:
the second operation comprises adjusting a position of a component of the vehicle, the component being one of a steering wheel, a mirror, and a seat,
the first contextual image comprises an image indicating a first adjustment operation on the component of the vehicle, an image indicating a second adjustment operation on the component of the vehicle, and an image indicating a confirm operation, wherein the image indicating a respective one of the first adjustment operation, the second adjustment operation, and the confirm operation is visually associated with a respective input region of the first touch pad, and
the first operation is different than adjusting the position of the component of the vehicle.

7. The vehicle of claim 1, further comprising a second display, wherein:
the second operation comprises receiving an indication of a vehicle warning,
in response to receiving the indication of the vehicle warning the vehicle displays, on the second display, a first visual indication of the vehicle warning,
in response to receiving the indication of the vehicle warning, the vehicle concurrently displays, on the HUD, a second visual indication of the vehicle warning and the first contextual control image,
the first contextual control image comprises an image indicating a dismiss operation, wherein the image indicating the dismiss operation is visually associated with the first input region of the first touch pad,
in response to the second user input, the vehicle ceases to display the second visual indication of the vehicle warning and the first contextual control image while continuing to display the first indication of the vehicle warning, and
the first operation is different than receiving the indication of the vehicle warning.

8. The vehicle of claim 1, further comprising:
a second touch pad comprising a plurality of input regions, wherein the method further comprises:
receiving an indication of a third user input at an input region of the second touch pad,
in response to receiving the indication of the third user input, displaying, on the HUD, a second contextual control image comprising a representation of the second touch pad and an image indicating a first driver assistance function and an image indicating a second driver assistance function, wherein a respective one of the first driver assistance function and the second driver assistance function is associated with a first characteristic of an input at the input region of the second touch pad,
receiving an indication of a fourth user input at the input region of the second touch pad, the fourth user input having the first characteristic, and
in response to receiving the fourth user input, performing the respective one of the first driver assistance function and the second driver assistance function in accordance with the first characteristic of the fourth user input.

9. The vehicle of claim 8, wherein, in response to receiving the fourth user input:
the vehicle enters an adaptive cruise control driving mode in accordance with the first characteristic of the fourth user input, and the method further comprises:
displaying, on the HUD, a third contextual control image comprising a representation of the second touch pad and an image indicating an increase speed operation, an image indicating a decrease speed operation, an image indicating an alter following distance operation, an image indicating an initiate third driver assistance function operation, and an image indicating a cease adaptive cruise control driving mode operation, wherein the image indicating a respective one of the increase speed operation, the decrease speed operation, the alter following distance operation, the initiate driver assistance function operation, and the cease adaptive cruise control driving mode operation is visually associated with a respective input region of the second touch pad,
receiving an indication of a fifth user input at the respective input region of the second touch pad, and
in response to the fifth user input, performing the respective one of the increase speed operation, the decrease speed operation, the alter following distance operation, the initiate third driver assistance function operation, and the cease adaptive cruise control driving mode operation in accordance with the respective input region of the second touch pad.

10. A non-transitory computer-readable medium including instructions, which when executed by one or more processors, cause the one or more processors to perform a method comprising:
receiving an indication of a first user input at an input region of a first touch pad;
in response to receiving the indication of the first user input, performing a first operation in accordance with the input region of the first touch pad;
performing a second operation;
in response to the second operation, displaying, on a heads-up display (HUD), a first contextual control image, the first contextual control image comprising a representation of the first touch pad and an image indicating a third operation associated with the first input region of the first touch pad, the third operation different from the first operation;
receiving an indication of a second user input at the first input region of the first touch pad; and
in response to receiving the indication of the second user input, performing the third operation in accordance with the input region of the first touch pad.

11. The non-transitory computer-readable medium of claim 10, wherein:
the second operation comprises receiving an indication of an incoming phone call,
the first contextual control image comprises an image indicating an answering operation and an image indicating a declining operation, wherein the image indicating a respective one of the answering operation and the declining operation is visually associated with the first input region of the first touch pad, and
the first operation is different than receiving the indication of the incoming phone call.

12. The non-transitory computer-readable medium of claim 10, wherein:
the second operation comprises executing a phone call of a phone operatively coupled to the one or more processors,
during the phone call, the first contextual control image comprises an image indicating a volume up operation, an image indicating a volume down operation, an image indicating a mute call operation, and an image indicating an end call operation, wherein the image indicating a respective one of the volume up operation, the volume down operation, the mute call operation, and the end call operation is visually associated with the first input region of the first touch pad, and
the first operation is different than executing the phone call.

13. The non-transitory computer-readable medium of claim 10, wherein:
the vehicle further comprises a second display,
the second operation comprises receiving an indication of a vehicle warning,
in response to receiving the indication of the vehicle warning the vehicle displays, on the second display, a first visual indication of the vehicle warning,
in response to receiving the indication of the vehicle warning, the vehicle concurrently displays, on the HUD, a second visual indication of the vehicle warning and the first contextual control image,
the first contextual control image comprises an image indicating a dismiss operation, wherein the image indicating the dismiss operation is visually associated with the first input region of the first touch pad,
in response to the second user input, the vehicle ceases to display the second visual indication of the vehicle warning and the first contextual control image while continuing to display the first indication of the vehicle warning, and
the first operation is different than receiving the indication of the vehicle warning.

14. The non-transitory computer-readable medium of claim 10, wherein:
the vehicle further comprises a second touch pad comprising a plurality of input regions, and the method further comprises:
receiving an indication of a third user input at an input region of the second touch pad,
in response to receiving the indication of the third user input, displaying, on the HUD, a second contextual control image comprising a representation of the second touch pad and an image indicating a first driver assistance function and an image indicating a second driver assistance function, wherein a respective one of the first driver assistance function and the second driver assistance function is associated with a first characteristic of an input at the input region of the second touch pad,
receiving an indication of a fourth user input at the input region of the second touch pad, the fourth user input having the first characteristic, and
in response to receiving the fourth user input, performing the respective one of the first driver assistance function and the second driver assistance function in accordance with the first characteristic of the fourth user input.

15. A method comprising:
receiving an indication of a first user input at an input region of a first touch pad;
in response to receiving the indication of the first user input, performing a first operation in accordance with the input region of the first touch pad;
performing a second operation;
in response to the second operation, displaying, on a heads-up display (HUD), a first contextual control image, the first contextual control image comprising a representation of the first touch pad and an image indicating a third operation associated with the first input region of the first touch pad, the third operation different from the first operation;
receiving an indication of a second user input at the first input region of the first touch pad; and
in response to receiving the indication of the second user input, performing the third operation in accordance with the input region of the first touch pad.

16. The method of claim 15, wherein:
the second operation comprises receiving an indication of an incoming phone call,
the first contextual control image comprises an image indicating an answering operation and an image indicating a declining operation, wherein the image indicating a respective one of the answering operation and the declining operation is visually associated with the first input region of the first touch pad, and
the first operation is different than receiving the indication of the incoming phone call.

17. The method of claim 15, wherein:
the second operation comprises executing a phone call of a phone operatively coupled to the one or more processors,
during the phone call, the first contextual control image comprises an image indicating a volume up operation, an image indicating a volume down operation, an image indicating a mute call operation, and an image indicating an end call operation, wherein the image indicating a respective one of the volume up operation, the volume down operation, the mute call operation, and the end call operation is visually associated with the first input region of the first touch pad, and
the first operation is different than executing the phone call.

18. The method of claim 15, wherein:
the vehicle further comprises a second display,
the second operation comprises receiving an indication of a vehicle warning,
in response to receiving the indication of the vehicle warning the vehicle displays, on the second display, a first visual indication of the vehicle warning,
in response to receiving the indication of the vehicle warning, the vehicle concurrently displays, on the HUD, a second visual indication of the vehicle warning and the first contextual control image,
the first contextual control image comprises an image indicating a dismiss operation, wherein the image indicating the dismiss operation is visually associated with the first input region of the first touch pad,
in response to the second user input, the vehicle ceases to display the second visual indication of the vehicle warning and the first contextual control image while continuing to display the first indication of the vehicle warning, and
the first operation is different than receiving the indication of the vehicle warning.

19. The method of claim 15, wherein:
the vehicle further comprises a second touch pad comprising a plurality of input regions, and the method further comprises:
receiving an indication of a third user input at an input region of the second touch pad,
in response to receiving the indication of the third user input, displaying, on the HUD, a second contextual control image comprising a representation of the second touch pad and an image indicating a first driver assistance function and an image indicating a second driver assistance function, wherein a respective one of the first driver assistance function and the second driver assistance function is associated with a first characteristic of an input at the input region of the second touch pad,
receiving an indication of a fourth user input at the input region of the second touch pad, the fourth user input having the first characteristic, and
in response to receiving the fourth user input, performing the respective one of the first driver assistance function and the second driver assistance function in accordance with the first characteristic of the fourth user input.

20. A vehicle comprising:
means for receiving an indication of a first user input at an input region of a first touch pad;
means for performing a first operation in accordance with the input region of the first touch pad in response to receiving the indication of the first user input;
means for performing a second operation;
means for displaying, on a heads-up display (HUD), in response to the second operation, a first contextual control image, the first contextual control image comprising a representation of the first touch pad and an image indicating a third operation associated with the first input region of the first touch pad, the third operation different from the first operation;
means for receiving an indication of a second user input at the first input region of the first touch pad; and
means for performing the third operation in accordance with the input region of the first touch pad in response to receiving the indication of the second user input.
